(19) United States
(12) Patent Application Publication
(10) Pub. No.: US 2010/0107825 A1
(43) Pub. Date: May 6, 2010

(54) Adjustable flange wrench

(76) Inventor: Richard James Pernosky, Upland, CA (US)

Correspondence Address: KOLISCH HARTWELL, P.C., 200 PACIFIC BUILDING, 520 SW YAMHILL STREET, PORTLAND, OR, 97204, US

(21) Appl. No.: 12/290,933

(22) Filed: Nov. 3, 2008

(51) Int. Cl. B25B 13/48

(52) U.S. Cl. 81/176.15

(57) ABSTRACT

An adjustable flange wrench is disclosed for use with variously sized flanges. The adjustable flange wrench includes a first body, a second body and a pair of pins. The second body is rotatably attached to the first body about a rotational axis and is rotatable between first and second positions relative to the first body. Each pin is engaged with the first body and extends through the second body. When the second body is in the first position, the pair of pins are maximally separated and are aligned along a first line that intersects the rotational axis. When the second body is in the second position, the pair of pins are minimally separated and are aligned along a second line that intersects the rotational axis and is offset from the first line.

### BACKGROUND

In the plumbing, heating and pipe fitting industries, flanges are commonly used to attach pumps, fluid control devices, valves, and other devices to pipes, pipe fittings or related equipment. Flanges having tapered female threads that are attached to the tapered male threads of a pipe by rotating the flange or pipe until the mating threads wedge together to form a leak-proof seal. To ensure such a seal, adequate torque must be applied to the flange when attaching it to the pipe.

A flange is often difficult to install with conventional plumbing tools due to the size, shape and weight of the flange, and/or due to the location of a pipe to which the flange must be attached. For example, a cast metal flange typically includes a “shoulder” intended to provide a “gripping” surface for a conventional pipe wrench. However, these shoulders are slightly tapered, which facilitates removal of the flange from the mold during the casting process, but causes the jaws of a conventional pipe wrench to slip from the shoulder during tightening. As such, these shoulders are often useless and potentially dangerous. The outer circumference of large and/or round flanges are also difficult to grip with the jaws of a conventional pipe wrench, due to either the limits of adjustability or inadequate length of the jaws. Finally, tightening a flange to a pipe in tight quarters can be tedious, tiring, time-consuming, and/or potentially dangerous due to limited or inadequate accessibility to a “gripping” surface, and due to the sheer weight of the flange and the tightening tools.

Examples of flange wrenches and other tools are found in U.S. Pat. Nos. 1,350,519; 1,425,845; 1,633,819; 1,677,637; 1,681,126; 2,386,254; 2,389,954; 2,402,477; 2,403,264; 2,580,247; 3,209,624; 4,092,882; 4,181,048; 4,327,755; 4,676,126; 5,839,331; 6,622,598; and 7,062,996, the disclosures of which are hereby incorporated by reference in their entirety for all purposes.

### BRIEF DESCRIPTION OF THE DRAWINGS

FIG. 1 is a perspective view of an embodiment of an adjustable flange wrench positioned below a round flange.

FIG. 2 is a top-down view of the adjustable flange wrench of FIG. 1 engaged with an irregularly shaped flange.

FIG. 3 is a top-down view of the adjustable flange wrench of FIG. 1 engaged with another irregularly shaped flange that is smaller than the irregularly shaped flange of FIG. 2.

FIG. 4 is an exploded view of the adjustable flange wrench of FIG. 1.

FIG. 5 is another exploded view of the adjustable flange wrench of FIG. 1.

FIG. 6 is a top-down view of the adjustable flange wrench of FIG. 1 in a first configuration.

FIG. 7 is a partial cross-sectional side view of the adjustable flange wrench of FIG. 1 in the first configuration.

FIG. 8 is a top-down view of the adjustable flange wrench of FIG. 1 in a second configuration.

FIG. 9 is a top-down view of the adjustable flange wrench of FIG. 1 in a third configuration.

### DETAILED DESCRIPTION

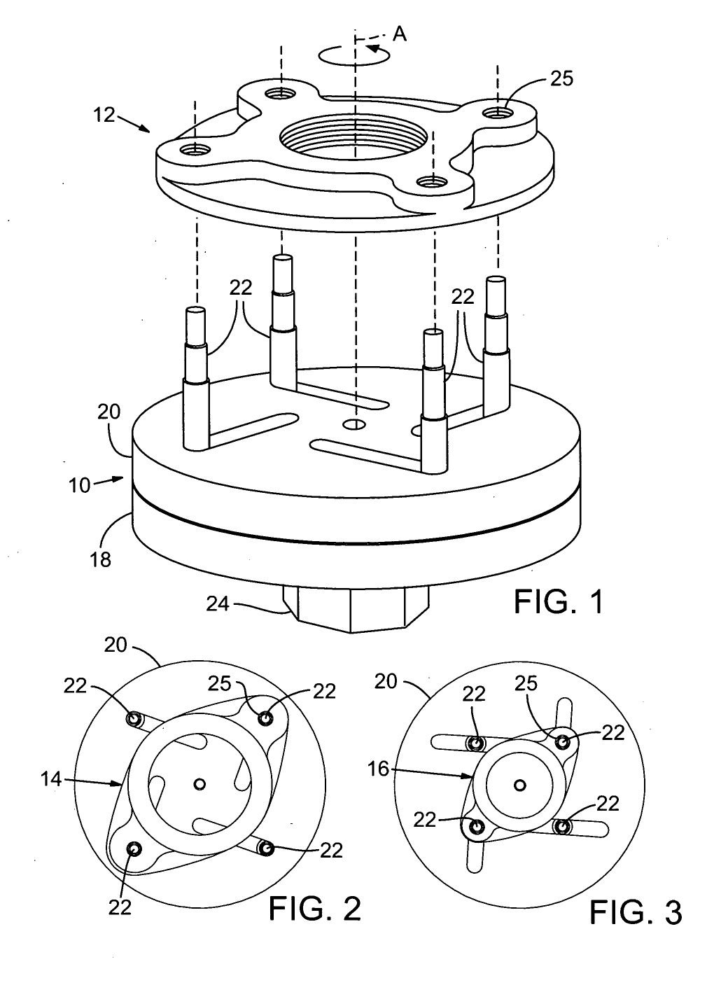

FIGS. 1-3 show an adjustable flange wrench 10 for attaching and/or removing differently sized/shaped pipe flanges, such as a round flange 12 and irregularly shaped flanges 14 and 16. The flange wrench 10 includes a first body 18, a second body 20 rotatably mounted to the first body about a rotational axis A, a plurality of adjustable pins 22 engaged with the first body and extending through the second body, and a hub 24 attached to the first body. Rotation of the second body relative to the first body dynamically adjusts the distance between the pins so that the pins can be inserted through the bolt holes 25 of differently sized and/or shaped flanges. The wrench 10 can then be used to attach the flange to, or detach the flange from a pipe by applying torque to the hub.

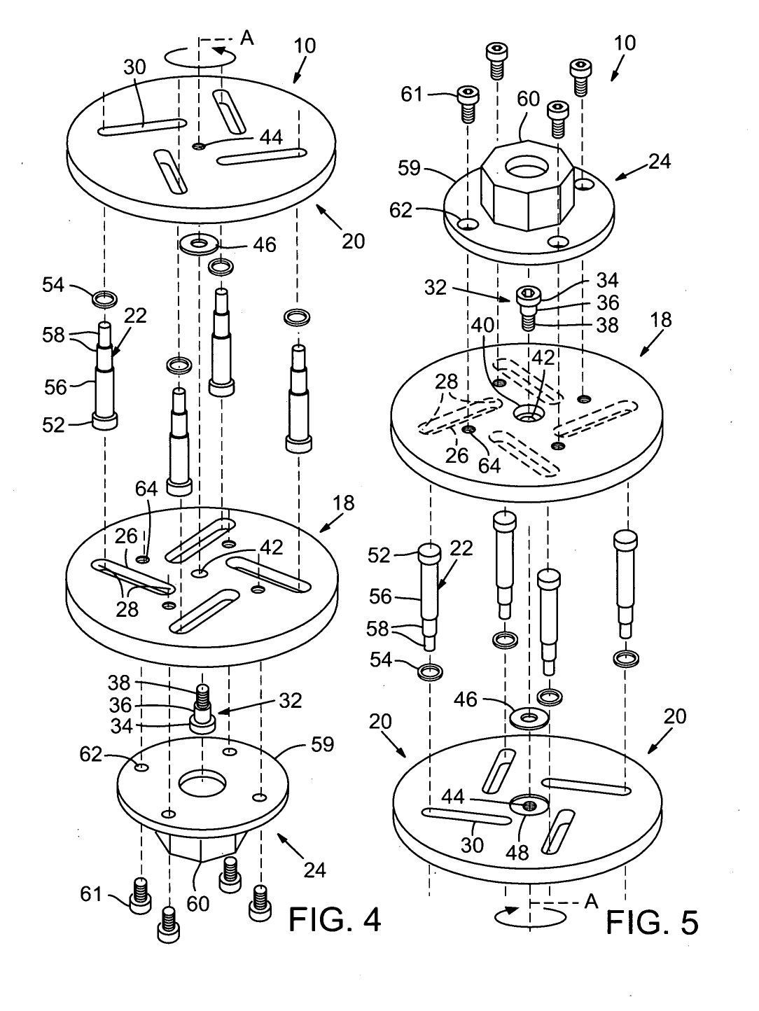

As shown in FIGS. 4 and 5, the first body 18 includes a plurality of channels 26 for receiving a portion of an associated pin 22, which is mounted in and displaceable along the channel. Each channel includes a pair of ends 28 that define the length of the channel, and thus the overall distance through which a pin can be displaced. Each channel has a predetermined width and depth that is complimentary to the width and depth of a channel-engaging portion 52 of its associated pin. As discussed below, rotation of the second body 20 relative to the first body displaces the pin along its associated channel through a plurality of positions. Each position along the length of the channel may be a different distance from the rotational axis A, such that rotation of the second body relative to the first body changes the distance between the pin and the rotational axis A. Each channel may be linear, such that rotation of the second body relative to the first body displaces the pin in a straight line.

The second body 20 is rotatably attached to the first body 18 about a rotational axis A, and includes a plurality of slots 30. In some embodiments, such as is shown in FIGS. 4 and 5, the second body may be rotatably attached to the first body with an axis bolt 32 having a bolt head 34, an unthreaded sleeve 36, a threaded end 38 and a longitudinal axis that is co-linear with the rotational axis A. The bolt head may fit within a recess 40 in the first body. The unthreaded sleeve may extend through an unthreaded central aperture 42 in the first body until the threaded end protrudes from the opposite side of the first body. The unthreaded sleeve thus may be rotatable within the unthreaded aperture. The threaded end may tightly secure to a threaded aperture 44 in the second body, thereby preventing withdrawal of the second body from the first body. The second body may be rotatable relative to the second body about the rotational axis A formed by the longitudinal axis of the axis bolt, because the unthreaded sleeve of the axis bolt is rotatable within the unthreaded aperture of the first body. In some embodiments, the mechanism for rotatably attaching the second body to the first body may include a washer 46 that fits within a recess 48 in the second body, and is sandwiched between the first and second bodies. In the absence of the pins 22, the second body would rotate freely relative to the first body, but as discussed below, the pins 22 constrain the degree to which the second body rotates relative to the first body.

Each of the plurality of slots 30 spans the width of the second body 20, and is dimensioned to allow a portion of an associated pin 22 extend therethrough, and to prevent the associated pin from being withdrawn from its associated channel 26. Each slot has a predetermined width that is complimentary to the width of an extending portion 56 of its associated pin, but is less than the width of the channel-engaging portion 52 of its associated pin. As such, the channel-engaging portion cannot be withdrawn through its associated slot, and is secured by the second body in its associated channel. As discussed below, each slot may be configured so that it overlaps a different position along the length of its associated channel as the second body is rotated relative to the first body 18. Rotation of the second body relative to the first body thus causes an associated slot and channel to apply a force to their associated pin that displaces the pin toward an end 28 of its associated channel. Each slot may be linear, and may form an angle with its associated channel for any rotational position of the second body relative to the first body.

The plurality of pins 22 may include a plurality of differently sized segments for engaging different portions of the first and second bodies 18 and 20, or for engaging differently dimensioned flange bolt holes. One end of each pin may include a channel-engaging portion 52 having dimensions that are complimentary to the dimensions of its associated channel 26. For example, the channel-engaging portion may be a cylindrical segment having a diameter and a depth that is slightly less than the width and depth of its associated channel 26, so that the pin can be mounted in and displaced along the length of the channel. The channel engaging portion may also include a separate washer 54 that fits over the pin and occupies space between the channel engaging segment of the pin and the second body. Each pin may include an extending portion 56 having dimensions that are complimentary to the dimensions of its associated slot 30. For example, the extending portion may be a cylindrical segment that extends away from the channel engaging portion and that has a diameter that is slightly less that the width of its associated slot. Because the slot is narrower than its associated channel, the extending portion is narrower, or has a smaller diameter, than the channel-engaging portion of the pin. Finally, the end of each pin opposite the channel-engaging end may include a plurality of substantially cylindrical elements 58 dimensioned to engage differently sized flange bolt holes, with each successive element having a smaller diameter than the previous element. As such, each pin may have a stepped appearance, and may be engaged with flanges having a variety of differently sized flange bolt holes.

The hub 24 is fixedly attached to the first body 18, and includes a securing plate 59 and an outwardly extending polygonal portion 60. The securing plate may be attached to the first body 18 with any suitable attachment mechanism, such as a plurality of bolts 61 for selectively bolt holes 62 in the hub and bolt holes 64 in the first body. The outwardly extending polygonal portion provides a gripping surface for a conventional drive tool, such as die ratchet, pipe wrench, monkey wrench, chain wrench, socket wrench, or any other tool for applying torque. The polygonal portion may be square, rectangular, hexagonal, octagonal, or any other polygonal shape that provides a gripping surface for affixing the drive tool.

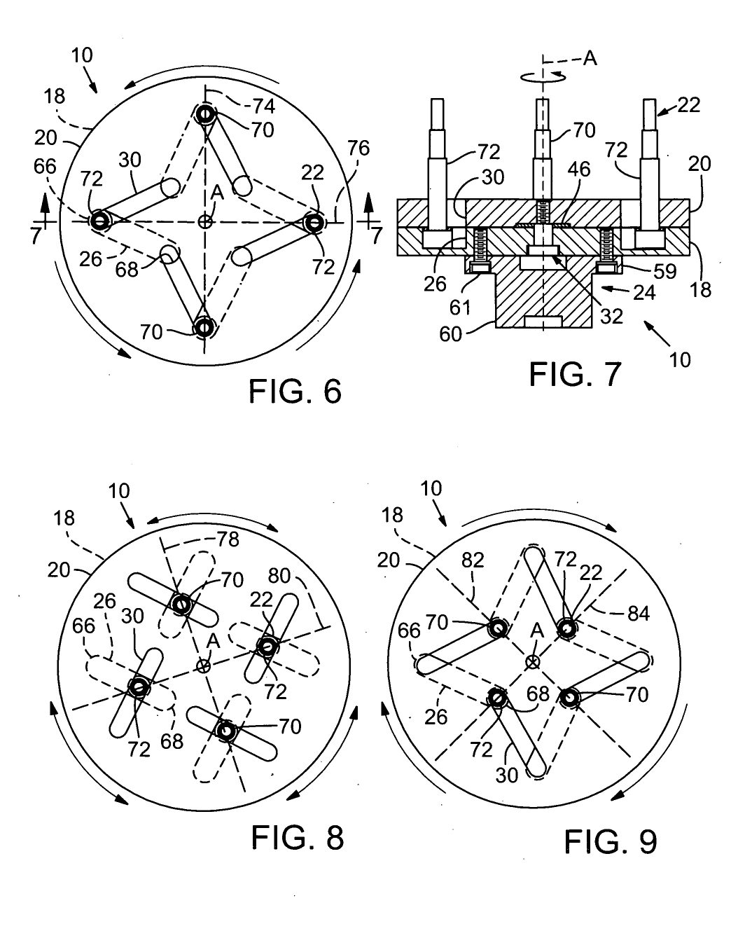

FIGS. 6-9 show an embodiment of a fully assembled flange wrench 10 with the second body 20 in various rotational positions relative to the first body 18. As discussed above, each channel 26 includes a pair of ends that define the length of the channel, where one end 66 is furthest from the rotational axis A, the other end 68 is closest to the rotational axis A, and each intermediate position along the length of the channel is a different distance from the rotational axis A. Each pin 20 is mounted in and displaceable along its associated channel and extends through and is displaceable along its associated slot 30. As discussed below, rotation of the second body relative to the first body displaces each pin along its associated channel and slot, thereby moving each pin relative to the rotational axis A.

Each slot 30 is configured to overlap a different position along the length of its associated channel 26 as the second body 20 is rotated relative to the first body 18, thereby displacing each pin 22 along the length of its associated channel. For example, in the embodiment shown in FIGS. 6-9, the channels and slots are configured so that clockwise rotation of the second body relative to the first body causes each slot to overlap its associated channel at positions that are progressively closer to the end 66 of its associated channel. This causes each associated slot and channel to apply a force to their associated pin 22 which displaces the pin toward the end 66 and further from the rotational axis A. After the second body is rotated clockwise to the rotational position shown in FIG. 6, where each slot overlaps a position adjacent to end 66 of its associated channel, the pins abut end 66 and prevent the second body from rotating any further in a clockwise direction. At this point, each pin is maximally separated from the rotational axis A, and as shown by the arrows in FIG. 6, the second body can only rotate in the counterclockwise direction. Counter-clockwise rotation of the second body 20 relative to the first body 18 causes each slot to overlap its associated channel at positions that are progressively nearer to the end 68 of its associated channel. This causes each associated slot and channel to apply a force to their associated pin which displaces the pin toward the end 68 and closer to the rotational axis A. After the second body is rotated counter-clockwise to the rotational position shown in FIG. 9, each slot overlaps a position adjacent to the end 68 of its associated channel, where the pins abut end 68 and prevent the second body from rotating any further in a counter-clockwise direction. At this point, each pin is minimally separated from the rotational axis A, and as shown by the arrows in FIG. 9, the second body can only rotate in the clockwise direction. When the second body is in an intermediate rotational position, such as is shown in FIG. 8, the second body can be rotated either clockwise or counterclockwise, thereby displacing the pins toward the ends 66 and 68, respectively, of their associated channels. The channels and slots may be configured so that the pins move between their maximally separated position (FIG. 6) and minimally separated position (FIG. 9) upon rotation of the second body 90 degrees relative to the first body.

The channels 26 and slots 30 can have different shapes and configurations than those shown in FIGS. 6-9, so long as they function together to move the pins further from or closer to the rotational axis A upon rotation of the second body 20 relative to the first body 18. For example, one or more of the channels and/or the slots may be nonlinear. Also, the channels and slots may be configured to move the pins further from or closer to the rotational axis when the second body is rotated in the counter-clockwise and clockwise directions, respectively.

The channels 26 and slots 30 may be configured to arrange one or more pairs of pins 22 symmetrically about the rotational axis A for every rotational position of the second body 20 relative to the first body 18. Flanges generally include one or more pairs of bolt holes, where both bolt holes in each pair of bolt holes are aligned along a single line that intersects the center of the flange, and are equidistant from the center of the flange. For example, the round flange 12 shown in FIG. 1 includes two pairs of such bolt holes 25, whereas the irregularly shaped flanges 14 and 16 shown in FIGS. 2 and 3 include one such pair of bolt holes. The distance between the bolt holes in each pair of bolt holes depends on the size of the flange. In the manner described below, the channels and slots of wrench 10 thus may be configured so that, for any rotational position of the second body relative to the first body, the flange wrench 10 includes one or more pairs of pins, where both pins in a pair of pins are equidistant from the rotational axis A and are aligned along a line that intersects the rotational axis A. Moreover, the distance between the pins in each pair of pins may be adjusted by rotating the second body relative to the first body, so that the flange wrench can be used -with differently sized flanges.

The embodiment of the flange wrench 10 shown in FIGS. 6, 8 and 9 includes two such pairs of adjustable pins 22 for use with variously sized flanges having one or more pairs of bolt holes. Specifically, the flange wrench 10 includes a first pair of pins comprised of pins 70, and a second pair of pins comprised of pins 72. The channels 26 and slots 30 may be configured such that for every rotational position of the second body 20 relative to the first body 18, both pins in a pair of pins are equidistant from the rotational axis A; and are aligned along a line that intersects the rotational axis.

For example, when the second body 20 is rotated to the rotational position shown in FIG. 6, pins 70 are maximally separated and equidistant from rotational axis A, and are aligned along a first line 74, whereas pins 72 are maximally separated and equidistant from rotational axis A, and are aligned along a second line 76. Pins 70 and 72 may all be equidistant and maximally separated from one another, such that pins 70 and 72 define the corners of a square, and lines 74 and 76 are orthogonal to one another. When the pins are maximally separated as shown in FIG. 6, they can be engaged with the bolt holes of relatively large round or irregularly shaped flanges, such as bolt holes 25 shown in FIGS. 1 and 2.

When the second body 20 is rotated to an intermediate position between the positions shown in FIGS. 6 and 9, such as the intermediate position shown in FIG. 8, pins 70 are equidistant from rotational axis A and are aligned along a line, such as a third line 78, whereas pins 72 are equidistant from rotational axis A and are aligned along another line, such as a fourth line 80. Pins 70 and 72 again may all be equidistant from one another, such that the pins define the corners of a square, and lines 78 and 80 are orthogonal to one another. If the channels 26 on the second body are not oriented radially from the rotational axis, then when the second body is in an intermediate rotational position, the line along which pins 70 are aligned, such as the third line 78, is offset from the first line 74, and the line along which pins 72 are aligned, such as the fourth line 80, is offset from the second line 76. When the pins are in an intermediate position, such as the one shown in FIG. 8, they can be engaged with the bolt holes of intermediately sized round or irregularly shaped flanges.

When the second body 20 is rotated to the rotational position shown in FIG. 9, pins 70 are minimally separated and equidistant from rotational axis A, and are aligned along a fifth line 82, whereas pins 72 are minimally separated and equidistant from rotational axis A, and are aligned along a sixth line 84. Pins 70 and 72 also may all be equidistant and minimally separated from one another, such that pins 70 and 72 define the corners of a square, and lines 82 and 84 are orthogonal to one another. If the channels 26 on the second body are not oriented radially from the rotational axis, then the fifth line 82 is offset from the first line 74 and the third line 78, and the sixth line 84 is offset from the second line 76 and the fourth line 80. When the pins are minimally separated as shown in FIG. 9, they can be engaged with the bolt holes of relatively small round or irregularly shaped flanges.

The flange wrench 10 may be configured to have adjustable pins 22 that can engage any sized flange, although in a preferred embodiment, the pins may dynamically adjust to engage bolt holes separated by distances between 2¾″ and 7″.

During operation, two or more pins 22 are engaged with the bolt holes of a flange, thereby fixing the relative distance between those pins and preventing the second body 20 from rotating appreciably relative to the first body 18. When torque is applied to the hub 22 with a drive tool, the channels 26 and slots 30 urge the pin towards an end of a channel as described above, thereby causing the pin to apply a force to the inner surface of the flanges bolt holes. This applied force creates friction between the pins and the bolt holes, and reduces the likelihood that the flange wrench 10 will disengage from the flange. When torque is no longer applied to the hub, the flange wrench relaxes, and the pins can be easily disengaged from the bolt holes.

The various components of the flange wrench disclosed herein may be any suitable material and may be any size and shape consistent with their functions. For example, the components may be made of stainless steel, steel, aluminum, plastics, or any other material having the desired traits of ease in manufacturing, strength, corrosion resistance, etc. The specific embodiments of a flange wrench as disclosed and illustrated herein are not to be considered in a limiting sense as numerous variations are possible. Ordinal indicators, such as first, second or third, for identified elements in the specification or the claims are used to distinguish between the elements, and do not indicate a required or limited number of such elements, and do not indicate a particular position or order of such elements unless otherwise specifically indicated. The subject matter of this disclosure includes all novel and non-obvious combinations and subcombinations of the various features, elements, functions and/or properties disclosed herein. No single feature, function, element or property of the disclosed embodiments is essential. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of the disclosure.

I claim:

1. An adjustable flange wrench, comprising:
a first body;
a second body rotatably attached to the first body about a rotational axis and rotatable between first and second positions relative to the first body;
a pair of pins, each pin engaged with the first body and extending through the second body;
wherein when the second body is in the first position, the pair of pins are maximally separated and are aligned along a first line that intersects the rotational axis, and when the second body is in the second position, the pair of pins are minimally separated and are aligned along a second line that intersects the rotational axis and is offset from the first line.

2. The adjustable flange wrench of claim 1, wherein each of the pair of pins are substantially equidistant from the rotational axis when the second body is in either the first or second positions.

3. The adjustable flange wrench of claim 1, wherein the second body rotates 90 degrees between the first and second positions.

4. The adjustable flange wrench of claim 1, wherein the first body includes a polygonal hub.

5. The adjustable flange wrench of claim 1, wherein each pin includes a plurality of cylindrical elements, each cylindrical element sized to engage a flange bolt hole having a different preselected diameter.

6. The adjustable flange wrench of claim 1, wherein the first body includes a pair of channels, and each pin is mounted in and displaceable along an associated one of the channels.

7. The adjustable flange wrench of claim 6, wherein the channels are linear.

8. The adjustable flange wrench of claim 6, wherein the second body includes a pair of slots, and each pin extends through an associated one of the slots.

9. The adjustable flange wrench of claim 8, wherein the slots are linear.

10. The adjustable flange wrench of claim 8, wherein a first channel associated with a first pin includes a pair of ends, and wherein when the second body is in the first position, a first slot associated with the first pin overlaps the first channel at a position adjacent to one end of the first channel, and when the second body is in the second position, the first slot overlaps the first channel at a position adjacent to the other end.

11. The adjustable flange wrench of claim 10, wherein when the second body is in the first position, the first pin abuts the one end, and when the second body is in the second position, the first pin abuts the other end.

12. The adjustable flange wrench of claim 1 further comprising:
a second pair of pins, each pin in the second pair engaged with the first body and extending through the second body;
wherein when the second body is in the first position, the second pair of pins are maximally separated and are aligned along a third line that intersects the rotational axis, and when the second body is in the second position, the pair of pins are minimally separated and are aligned along a fourth line that intersects the rotational axis and is offset from the third line.

13. The adjustable flange wrench of claim 12, wherein the pins in the pair of pins and in the second pair of pins are all substantially equidistant from the rotational axis when the second body is in either the first or second positions.

14. The adjustable flange wrench of claim 13, wherein each of the pins in the pair of pins and in the second pair of pins define a corner of a square when the second body is in either the first or second positions.

15. An adjustable flange wrench, comprising:
a first body including a plurality of linear channels;
a second body rotatably attached to the first body about a rotational axis, and including a plurality of slots;
a plurality of pins, each pin mounted in and displaceable along an associated channel and extending through and displaceable along an associated slot;
wherein rotation of the second body relative to the first body displaces each pin along its associated channel and slot, thereby moving each pin relative to the rotational axis.

16. The adjustable flange wrench of claim 15, wherein the first body includes a polygonal hub.

17. The adjustable flange wrench of claim 15, wherein each pin includes a plurality of cylindrical elements, each cylindrical element sized to engage a flange bolt hole having a different preselected diameter.

18. The adjustable flange wrench of claim 15, wherein rotation of the second body in one direction causes at least one pin to move closer to the rotational axis, and rotation of the second body in the other direction causes the at least one pin to move farther from the rotational axis.

19. The adjustable flange wrench of claim 15, wherein each of the plurality of channels has an end, and wherein rotation of the second body relative to the first body displaces each pin toward the end of its associated channel.

20. The adjustable flange wrench of claim 19, wherein rotation of the second body relative to the first body causes a force to be applied to each pin by its associated slot, thereby displacing each pin toward the end of its associated channel.

21. The adjustable flange wrench of claim 15, wherein the plurality of pins includes a pair of pins, and wherein when the second body is in a first rotational position relative to the first body, the pair of pins are aligned along a first line that intersects the rotational axis.

22. The adjustable flange wrench of claim 21, wherein each of the pair of pins are substantially equidistant from the rotational axis when the second body is in the first rotational position.

23. The adjustable flange wrench of claim 18, wherein when the second body is in the first rotational position, the pair of pins are maximally separated, and when the second body is in a second rotational position relative to the first body, the pair of pins are minimally separated and are aligned along a second line that intersects the rotational axis and is offset from the first line.

24. The adjustable flange wrench of claim 23, wherein the second body rotates 90 degrees between the first and second rotational positions.
